(19) United States
(12) Patent Application Publication
(10) Pub. No.: US 2019/0338094 A1
(43) Pub. Date: Nov. 7, 2019

(54) QUARTZ GLASS FIBER-CONTAINING PREPREG AND QUARTZ GLASS FIBER-CONTAINING SUBSTRATE

(71) Applicant: SHIN-ETSU CHEMICAL CO., LTD., Tokyo (JP)

(72) Inventors: Yoshihira HAMAMOTO, Takasaki-shi (JP); Yoshihiro TSUTSUMI, Annaka-shi (JP); Naoyuki KUSHIHARA, Annaka-shi (JP); Yuki KUDO, Annaka-shi (JP)

(73) Assignee: SHIN-ETSU CHEMICAL CO., LTD., Tokyo (JP)

(21) Appl. No.: 16/373,688

(22) Filed: Apr. 3, 2019

(30) Foreign Application Priority Data
May 1, 2018 (JP) 2018-88436

(51) Int. Cl. C08J 5/24; C08F 22/40; C08K 3/36; C08L 35/00; C08L 63/00; C08L 83/04

(52) U.S. Cl. CPC C08J 5/24; C08F 22/40; C08K 3/36; C08L 35/00; C08L 63/00; C08J 2483/04; C08J 2335/00; C08J 2435/00; C08J 2363/00; C08J 2463/00; C08J 2383/04; C08L 83/04

(57) ABSTRACT

The present invention is a quartz glass fiber-containing prepreg, including: (A) at least one quartz glass fiber selected from the group consisting of a quartz cloth, a quartz chopped strand, a quartz nonwoven fabric, and a quartz wool; as well as a resin composition including (B) a maleimide compound that is a solid at 25° C., containing at least one dimer acid skeleton, at least one linear alkylene group having 6 or more carbon atoms, and at least two maleimide groups in the molecule; and (C) a curing accelerator, wherein the total content of uranium and thorium is 0 to 0.1 ppm. This provides a quartz glass fiber-containing prepreg to give a quartz glass fiber-containing substrate that is used as a PCB to prevent malfunction of a semiconductor device caused by the PCB to decrease transmission loss.

### TECHNICAL FIELD

The present invention relates to a quartz glass fiber-containing prepreg and a quartz glass fiber-containing substrate using the same.

### BACKGROUND ART

With remarkable progress of digital technology, electronic devices such as personal computers and mobile phones have been thinned, miniaturized and advanced. For example, high-density mounting, thinning and miniaturizing are required for a printed substrate, which is a representative component. To meet these requirements, glass fiber-containing substrates and films are strongly required to improve in their properties. It is particularly important not to cause malfunction.

Also, higher speed and frequency of computers, mobile phones, communications infrastructures and other devices have been developed. Accordingly, print circuit substrates have been required to have properties of excellent transmission loss, and these substrates and films with lower dielectric constant have been demanded (Patent Document 1).

Previously, glass clothes used for a substrate and a film have been woven from E-glass fibers or D-glass fibers (Patent Documents 2 to 4). Among the glass fibers, quartz fibers, having particularly low dielectric constant and dielectric loss, has attracted attentions. However, the quartz glass fibers, especially synthesis quartz glass fibers have been highly purified and are very expensive in costs thereby (Patent Document 5).

### CITATION LIST

### Patent Literature

Patent Document 1: Japanese Patent Laid-Open Publication No. 2016-131243

Patent Document 2: Japanese Patent Laid-Open Publication No. H09-74255

Patent Document 3: Japanese Patent Laid-Open Publication No. H02-61131

Patent Document 4: Japanese Patent Laid-Open Publication No. S62-169495

Patent Document 5: Japanese Patent Laid-Open Publication No. 2004-99377

### SUMMARY OF INVENTION

### Technical Problem

The present invention has been investigated in view of the above circumstances, and it is an object of the present invention to provide a quartz glass fiber-containing prepreg to give a quartz glass fiber-containing substrate that is used as a print circuit board (hereinafter abbreviated as PCB) to prevent malfunction of a semiconductor device caused by the PCB to decrease transmission loss.

### Solution to Problem

To solve the problems, the present invention provides a quartz glass fiber-containing prepreg, comprising:

(A) at least one quartz glass fiber selected from the group consisting of a quartz cloth, a quartz chopped strand, a quartz nonwoven fabric, and a quartz wool; and

a resin composition comprising:

(B) a maleimide compound that is a solid at 25° C., containing at least one dimer acid skeleton, at least one linear alkylene group having 6 or more carbon atoms, and at least two maleimide groups in the molecule; and

(C) a curing accelerator,

wherein the prepreg has a total content of uranium and thorium of 0 to 0.1 ppm.

The prepreg like this gives a quartz glass fiber-containing substrate that is used as a PCB to prevent malfunction of a semiconductor device caused by the PCB to decrease transmission loss.

It is preferable that the quartz glass fiber-containing prepreg further comprise (D) inorganic filler.

With the resin composition containing inorganic filler, the quartz glass fiber-containing prepreg comes to have sufficient strength.

It is preferable that (A) the quartz glass fiber have a fiber diameter of 3 to 9 μm and a fictive temperature of 1,200 to 1,600° C.

The quartz glass fiber like this allows the quartz glass fiber-containing prepreg to give a substrate with better processability.

It is preferable that the resin composition further contain (E) at least one curable resin selected from the group consisting of a silicone resin, a curable polyimide resin, an epoxy resin, a cyanate resin, and a (meth)acrylic resin.

Having such a resin, the quartz glass fiber-containing prepreg gives a substrate with various properties such as better processability and heat resistance.

It is preferable that (B) the maleimide compound be shown by at least one of the following general formulae (1) and (2):

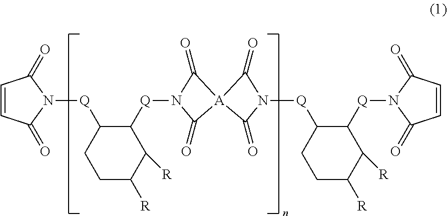

wherein “A” represents a quadrivalent organic group containing an aromatic ring or an aliphatic ring, Q represents a linear alkylene group having 6 or more carbon atoms, each R independently represents a linear or branched alkyl group having 6 or more carbon atoms, and “n” is an integer of 1 to 10,

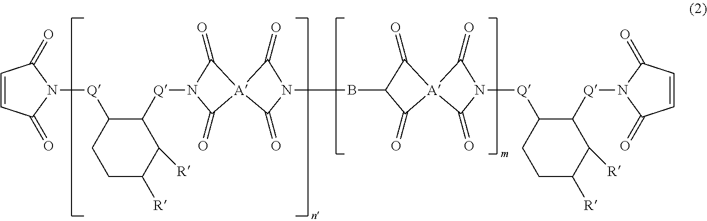

wherein “A′” represents a quadrivalent organic group containing an aromatic ring or an aliphatic ring, B represents an alkylene chain having 6 to 18 carbon atoms and an aliphatic ring optionally containing at least one divalent hetero atom, Q′ represents a linear alkylene group having 6 or more carbon atoms, each R′ independently represents a linear or branched alkyl group having 6 or more carbon atoms, “n′” is an integer of 1 to 10, and “m” is an integer of 1 to 10.

Having the maleimide compound like this as the component (B), the quartz glass fiber-containing prepreg gives a substrate with excellent dielectric properties and tracking resistance as well as lower modulus of elasticity.

It is preferable that the general formula (1) and the general formula (2) have any of the following structures as “A” and “A′”

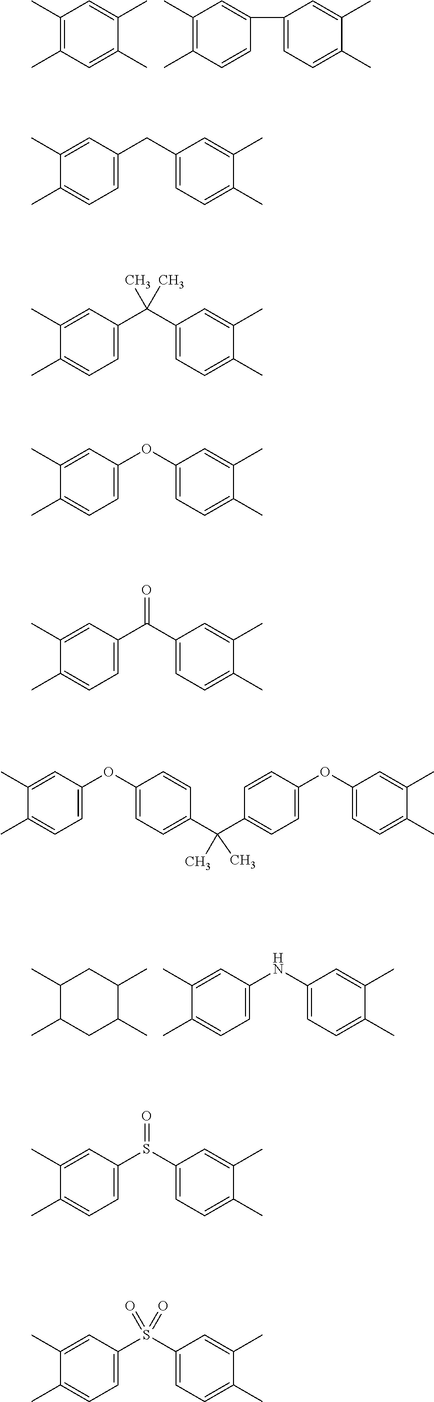

wherein each bond without having a substituent in the structural formulae is bonded to a carbonyl carbon atom forming a cyclic imide structure in the general formula (1) or the general formula (2).

In the present invention, the maleimide compound having such a structure can be used favorably as the component (B).

The present invention also provides a quartz glass fiber-containing substrate, comprising a cured material of a sheet composed of the quartz glass fiber-containing prepreg described above or a laminated cured material of the sheets, the substrate having a relative dielectric constant of 3.0 or less and a dielectric tangent of 0.0005 to 0.008 in a range of 10 to 100 GHz.

Using the quartz glass fiber-containing substrate like this as a PCB, semiconductor devices are successfully prevented from causing malfunction.

It is preferable that the dielectric tangent at 1 GHz and the dielectric tangent at 10 GHz differ by 0 to 0.01.

The material like this is more favorable to be applied to various electronic parts such as a PCB.

### Advantageous Effects of Invention

As described above, the inventive quartz glass fiber-containing prepreg has extremely small contents of uranium and thorium, which induce malfunctions of semiconductor devices, and gives a quartz glass fiber-containing substrate that is useful as a substrate for a semiconductor. Using a quartz glass fiber and the maleimide resin having a specific structure, the prepreg and the substrate each have a lower dielectric constant and a lower dielectric tangent, and a high-frequency compatible prepreg and a PCB are provided.

### DESCRIPTION OF EMBODIMENTS

As described above, it has been demanded for developing a quartz glass fiber-containing prepreg to give a quartz glass fiber-containing substrate that is used as a PCB to prevent malfunctions of a semiconductor device caused by the PCB to decrease transmission loss.

The present inventors have diligently investigated the above subjects. As a result, the inventors have found that semiconductor devises cause malfunctions by radiation from a substrate due to uranium and thorium, which are radioactive elements, thereby bringing the present invention to completion.

That is, the present invention is a quartz glass fiber-containing prepreg, comprising:

(A) at least one quartz glass fiber selected from the group consisting of a quartz cloth, a quartz chopped strand, a quartz nonwoven fabric, and a quartz wool; and

a resin composition comprising:

(B) a maleimide compound that is a solid at 25° C., containing at least one dimer acid skeleton, at least one linear alkylene group having 6 or more carbon atoms, and at least two maleimide groups in the molecule; and

(C) a curing accelerator,

wherein the total content of uranium and thorium is 0 to 0.1 ppm.

Hereinafter, the present invention will be specifically described, but the present invention is not limited thereto.

### <Quartz Glass Fiber-Containing Prepreg>

The inventive quartz glass fiber-containing prepreg contains a quartz glass fiber, which is the component (A) described below, and a resin composition containing the components (B) and (C) described below.

The inventive quartz glass fiber-containing prepreg has a total content of uranium and thorium of 0 to 0.1 ppm, preferably 0 to 0.01 ppm, more preferably 0 to 0.005 ppm. Using a prepreg having the amount of more than 0.1 ppm, electronic parts such as a substrate are liable to affect to semiconductor devices, thereby causing malfunctions of memories and so on. Incidentally, the contents of uranium (U) and thorium (Th) refer to values measured by ICP-MS.

The inventive quartz glass fiber-containing prepreg can be produced by ordinary methods for producing a glass fiber-containing substrate or film, prepreg, etc., such as impregnating or coating quartz glass fibers with a resin composition, but is not particularly limited thereto. For example, it can be produced by an ordinary method for coating glass fibers with a curable resin composition (coating method) or by impregnating quartz glass fibers with a resin composition.

Illustrative examples of typical coating system include a direct gravure coater, a chamber doctor coater, an offset gravure coater, a single roll kiss coater, a reverse kiss coater, a bar coater, a reverse roll coater, a slot die, an air doctor coater, a normal rotation roll coater, a blade coater, a knife coater, an impregnation coater, an MB coater, and an MB reverse coater.

In order to improve and ensure the coating properties, the curable resin composition may be diluted with a solvent. Because of the solubility properties of the curable resin, an organic solvent(s) can be used singly or as a mixture of two or more kinds. Illustrative examples of the organic solvent include alcohols such as methanol, ethanol, isopropanol, and n-butanol; ketones such as acetone, methyl ethyl ketone, and methyl isobutyl ketone; glycol ethers such as ethylene glycol and propylene glycol; aliphatic hydrocarbons such as hexane and heptane; aromatic hydrocarbons such as toluene and xylene; and ethers such as diethyl ether, diisopropyl ether, and di-n-butyl ether.

To (A) the quartz glass fiber, the attached amount of a curable resin composition, which contains essential components of the component (B) and the component (C) described later, is preferably 30 mass % or more and 80 mass % or less. This range is preferable because of the appropriate ratio of the resin composition and the quartz glass fiber. The resin amount of 30 mass % or more brings adequate amount of resin to adhere to a copper foil to be stuck, thereby giving sufficient peel strength to the copper foil. The resin amount of 80 mass % or less is preferable because the resin is not in excess, and the resin tends to prevent flowing in pressing. Incidentally, the applied amount herein refers to a value in mass % of the curable resin composition relative to the mass of the whole prepreg.

The curable resin composition may be applied by a method of applying the composition, followed by drying and subsequent heating for curing at room temperature (25° C.) to 300° C. for 1 minute to 24 hours, for example, although the conditions differ depending on the composition to be used.

### [(A) Quartz Glass Fiber]

The quartz glass fiber in the present invention is at least one fiber selected from the group consisting of a quartz cloth, a quartz chopped strand, a quartz nonwoven fabric, and a quartz wool. It may be fibrous, a fabric called glass cloth, a quartz chopped strand, a quartz nonwoven fabric, or a quartz wool, however, a quartz glass cloth is preferably used because it can be handled easily. The quartz glass cloth is produced, for example, using quartz glass strands and/or quartz glass yarns. The quartz glass strand and/or the quartz glass yarn are a bundle of 50 or more and 500 or less of the quartz glass fibers. Incidentally, the present description describes the fibers bundled without being twisted as a strand, and the fibers bundled by twisting as a yarn.

As described above, the inventive quartz glass fiber-containing prepreg has a total content of uranium and thorium of 0 to 0.1 ppm. Accordingly, the quartz glass fiber in the present invention preferably has a content of uranium and thorium of 0 to 0.1 ppm, more preferably 0.01 to 50 ppb.

The temperature at which the glass molecules are fixed is referred to as a fictive temperature, and the glass fiber possesses better processability as the fictive temperature is higher. For example, when the fictive temperature is 1,200° C. or more, the processability is improved compared to the case having lower fictive temperature. On the other hand, the fictive temperature of 1,600° C. or less prevents the risk of increasing the instability of the structure. In the present invention, the quartz glass fiber preferably has a fictive temperature in a range of 1,300 to 1,500° C. in view of the processability, mass-productivity, and structural stability of the glass fiber. The fiber diameter is preferably 3 to 9 m.

### [Resin Composition]

The resin composition in the present invention is a heat curable resin composition that contains essential components of the components (B) and (C) described later. The resin composition in the present invention may be prepared by any method such as mixing the components described later by previously known method, and the preparation method is not particularly limited.

### <(B) Maleimide Compound>

The component (B) of the present invention is a maleimide compound that is a solid at 25° C., with the molecule containing at least one dimer acid skeleton, at least one linear alkylene group having 6 or more carbon atoms, and at least two maleimide groups. It may also has a linear alkyl group. Having a linear alkylene group with 6 or more carbon atoms, the content of phenyl group is relatively decreased to improve the tracking resistance not only achieving excellent dielectric properties. Having a linear alkylene group, the modulus of elasticity can be decreased, which is effective for decreasing the stress on a semiconductor device due to the cured material.

Among them, the component (B) is preferably a maleimide compound having a long chain alkyl group shown by the following general formula (1) and/or the following general formula (2). The maleimide compounds (1) and (2) are preferably formulated in a ratio of 99:1 to 10:90, more preferably 99:1 to 50:50.

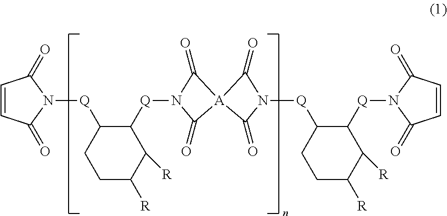

In the formula, “A” represents a quadrivalent organic group containing an aromatic ring or an aliphatic ring, Q represents a linear alkylene group having 6 or more carbon atoms, each R independently represents a linear or branched alkyl group having 6 or more carbon atoms, and “n” is an integer of 1 to 10.

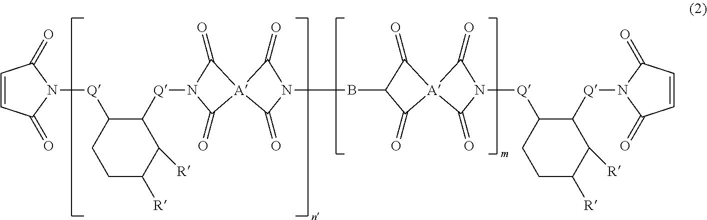

In the formula, “A′” represents a quadrivalent organic group containing an aromatic ring or an aliphatic ring, B represents an alkylene chain having 6 to 18 carbon atoms and an aliphatic ring optionally containing at least one divalent hetero atom, Q′ represents a linear alkylene group having 6 or more carbon atoms, each R′ independently represents a linear or branched alkyl group having 6 or more carbon atoms, “n′” is an integer of 1 to 10, and “m” is an integer of 1 to 10.

In Q in the general formula (1) and Q′ in the general formula (2), which are linear alkylene groups, each number of carbon atom is 6 or more, preferably 6 or more and 20 or less, more preferably 7 or more and 15 or less. In R in the general formula (1) and R′ in the general formula (2), which are alkyl groups that may be linear or branched, each number of carbon atom is 6 or more, preferably 6 or more and 12 or less.

Each of “A” in the general formula (1) and “A′” in the general formula (2) represents a quadrivalent organic group containing an aromatic ring or an aliphatic ring, preferably any of the quadrivalent organic groups shown by the following structural formulae.

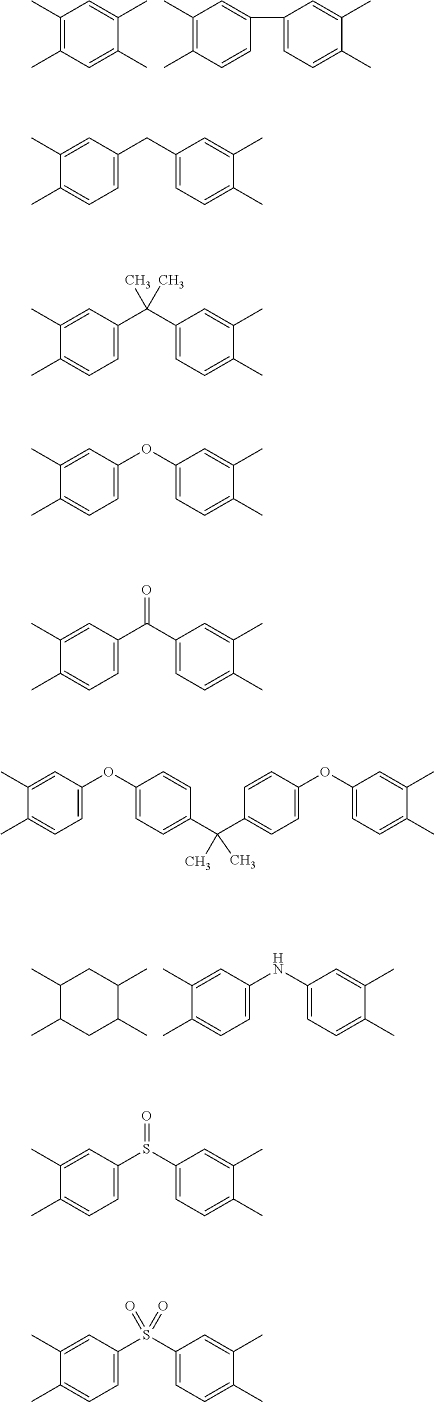

In the structural formulae, each bond without having a substituent is bonded to a carbonyl carbon atom forming a cyclic imide structure in the general formula (1) or the general formula (2).

In the general formula (2), B represents an alkylene chain having an aliphatic ring optionally containing at least one divalent hetero atom, in which the number of carbon atom in the alkylene chain is 6 to 18, preferably 8 or more and 15 or less.

In the general formula (1), “n” is an integer of 1 to 10, preferably 3 to 10. In the general formula (2), “n′” is an integer of 1 to 10, preferably 3 to 10. In the general formula (2), “m” is an integer of 1 to 10, preferably 3 to 10.

In the present invention, the weight average molecular weight (Mw) of the maleimide compound of the component (B) is not particularly limited, if it is in such a range that the maleimide compound is a solid at room temperature (25° C.). The weight average molecular weight is preferably 2,000 to 500,000, more preferably 3,000 to 400,000, still more preferably 5,000 to 300,000 measured by gel permeation chromatography (GPC) in terms of polystyrene standard. Having a molecular weight of 2,000 or more, the obtained maleimide compound tends to be solidified. Having a molecular weight of 500,000 or less, the maleimide compound provides a composition with good properties for coating a cloth without a risk of lowering the fluidity of varnish due to excessively increased viscosity in preparing a prepreg.

Incidentally, Mw in this description refers to the weight average molecular weight measured by GPC under the following conditions in terms of polystyrene standard.

### [Measurement Conditions]

Developing solvent: tetrahydrofuran
Flow amount: 0.35 mL/min

### Detector: RI

Column: TSK gel H type (manufactured by Tosoh Corporation)
Column temperature: 40° C.
Sample injection amount: 5 μL

As the maleimide compound of the component (B), commercially available articles can be used, including BMI-2500, BMI-2560, BMI-3000, BMI-5000, BMI-6100 (all of them manufactured by Designer Molecules Inc.).

The maleimide compound can be used singly or in combination of two or more kinds. In case of using a plurality of compounds, any maleimide compound can be used regardless of the properties if it is compatible with the maleimide compound of the component (B). The content of uranium and thorium in (B) the maleimide compound is preferably 0 to 0.1 ppm, more preferably 0 to 0.001 ppm.

### <(C) Curing Accelerator>

To the resin composition in the present invention, a curing accelerator is added as the component (C). The curing accelerator is used not only for accelerating the reaction of the maleimide of the component (B) but also for accelerating the reaction of the curable resin of the component (E) described later, and the type is not particularly limited.

As the curing accelerator (polymerization initiator) only for accelerating the reaction of the component (B), a thermal-radical polymerization initiator is preferable in view of conducting heat molding, although the type is not particularly limited thereto. Illustrative examples of the thermal-radical polymerization initiator include dicumyl peroxide, t-hexyl hydroperoxide, 2,5-dimethyl-2,5-bis(t-butylperoxy)hexane, α,α′-bis(t-butylperoxy) diisopropylbenzene, t-butyl cumyl peroxide, and di-t-butyl peroxide. The thermal-radical polymerization initiator is more preferable than photo-radical polymerization initiators in view of handling properties and shelf stability.

The curing accelerator like this can be used alone or in combination of two or more kinds regardless of the type. The amount to be added is preferably 0.0001 to 10 parts by mass, more preferably 0.0001 to 5 parts by mass relative to 100 parts by mass of the whole component (B).

In addition to the above components, the resin composition in the present invention can contain the following optional component(s).

### <(D) Inorganic Filler>

In order to improve the strength of a cured material of the inventive quartz glass fiber-containing prepreg, inorganic filler can be formulated as a component (D). The inorganic filler of the component (D) is not particularly limited and can be the one ordinarily formulated to epoxy resin compositions or silicone resin compositions. Illustrative examples thereof include silica such as spherical silica, fused silica, and crystalline silica; alumina, silicon nitride, aluminum nitride, boron nitride, glass fibers, and glass particles; and additionally, filler containing or coated with a fluorine resin to improve the dielectric properties.

The average particle diameter and the shape of the inorganic filler of the component (D) are not particularly limited. The average particle diameter is, however, ordinarily 3 to 40 μm. As the component (D), spherical silica with the average particle diameter of 0.5 to 40 m is preferably used. Incidentally, the average particle diameter is a value determined as a mass average particle size D₅₀ (or median diameter) in particle size distribution measurement using laser diffractometry.

In view of increasing the fluidity of the obtained composition, it is possible to use a combination of inorganic fillers with different particle diameter ranges. In this case, it is preferable to use the combination of spherical silicas in a fine particle size range of 0.1 to 3 μm, in a middle particle size range of 3 to 7 m, and in a coarse particle size range of 10 to 40 μm. For further increasing the fluidity, it is preferable to use a spherical silica having still larger average particle diameter.

The content of the inorganic filler of the component (D) is preferably 300 to 1,000 parts by mass, particularly 400 to 800 parts by mass relative to 100 parts by mass of the total amount of the resin components such as the component (B). The inorganic filler in an amount of 300 parts by mass or more gives sufficient strength. The inorganic filler in an amount of 1,000 parts by mass or less eliminates risks of short shot due to increase of the viscosity and lacking of flexibility to prevent a risk of causing failure such as peeling in a device. Incidentally, this inorganic filler is preferably contained in an amount ranging 10 to 90 mass %, particularly 20 to 85 mass % relative to the whole composition.

The inorganic filler to be added has a content of uranium and thorium of 0 to 0.1 ppm, preferably 0.0001 to 0.001 ppm. As the inorganic filler, inorganic filler produced from synthetic material is more preferable than inorganic filler produced from natural minerals because the contents of uranium and thorium are smaller.

### <(E) Curable Resin>

The curable resin of the component (E) is preferably a thermosetting resin (a heat-hardening resin) and/or a photo-curable resin, and may have any state of liquid, semi-solid, or solid at ordinary temperature (25° C.). Illustrative examples thereof include (E1) an epoxy resin, (E2) a silicone resin, (E3) a curable polyimide resin, (E4) a cyanate resin, and (E5) a (meth)acrylic resin. Among them, an epoxy resin, a silicone resin, and a curable polyimide resin are preferably used. Incidentally, the curable resin can be used alone or in combination of two or more resins.

In order to accelerate the reaction of the component (E), an ordinary material (catalyst) can be used by which the curing reaction of a silicone resin or an epoxy resin composition is accelerated, and the type is not particularly limited. As the catalyst, platinum base catalysts used for a silicon resin can be exemplified, including H₂PtCl₆.yH₂O, K₂PtCl₆, KHPtCl₆.yH₂O, K₂PtCl₄, K₂PtCl₄.yH₂O, and PtO₂.yH₂O (y is a positive integer). The platinum base catalyst can be used as a complex with hydrocarbon such as olefin, alcohol, or vinyl group-containing organopolysiloxane. The catalyst may be used singly or in combination of two or more kinds.

Illustrative examples of the curing catalyst for an epoxy resin include amine compounds such as 1,8-diazabicyclo[5.4.0]undec-7-ene; organic phosphorus compounds such as triphenyl phosphine and tetraphenylphosphonium tetrafluoroborate; and imidazole compounds such as 2-methylimidazole.

The amount of the curing catalyst is preferably 0.0001 to 10 parts by mass, more preferably 0.0001 to 5 parts by mass relative to 100 parts by mass of the component (E).

### (E1) Epoxy Resin

The epoxy resin of the component (E1) reacts with a curing agent for an epoxy resin, which can be used for improving the fluidity and mechanical properties of the thermosetting resin composition in the present invention and will be described later, or the maleimide compound of the component (B) to form a three dimensional bonds. The epoxy resin is not particularly limited, and any epoxy resin having two or more epoxy groups in the molecule can be used. In view of handling properties, the epoxy resin is preferably a solid at room temperature (25° C.), more preferably a solid having a melting point of 40° C. or more and 150° C. or less or a softening temperature of 50° C. or more and 160° C. or less.

Illustrative examples of the epoxy resin include bisphenol type epoxy resins such as a bisphenol A type epoxy resin, a bisphenol F type epoxy resin, 3,3′,5,5′-tetramethyl-4,4′-bisphenol type epoxy resin, and a 4,4′-bisphenol type epoxy resin; a phenol-novolak type epoxy resin, a cresol novolak type epoxy resin, a bisphenol A novolak type epoxy resin, a naphthalenediol type epoxy resin, a triphenylolmethane type epoxy resin, a tetrakisphenylolethane type epoxy resin, a phenoldicyclopentadiene-novolak type epoxy resin in which the aromatic ring is hydrogenated, an epoxy resin of triazine derivative, and an alicyclic epoxy resin. Among them, a bisphenol A type, a phenol-novolak type, and a cresol novolak type are preferably used.

### (F) Curing Agent for Epoxy Resin

Illustrative examples of the curing agent for the epoxy resin include a phenolic (phenol-based) curing agent, an amine-based curing agent, an acid anhydride-based curing agent, and a benzooxazine derivative. For encapsulating a semiconductor, a phenolic curing agent and a benzooxazine derivative are preferable; and an acid anhydride-based curing agent is preferable for low dielectric uses.

As the phenolic curing agent, any curing agent having two or more phenolic hydroxy groups in the molecule can be used without being particularly limited. In view of handling properties, the phenolic curing agent is preferably a solid at room temperature (25° C.), more preferably a solid having a melting point of 40° C. or more and 150° C. or less or a softening temperature of 50° C. or more and 160° C. or less. Illustrative examples of the phenolic curing agent include a phenol novolak resin, a cresol novolak resin, a phenol aralkyl resin, a naphthol aralkyl resin, a terpene-modified phenol resin, and a dicylopentadiene-modified phenol resin. They can be used singly or in combination of two or more kinds.

The phenolic curing agent is preferably formulated so as to have an equivalent ratio of the phenolic hydroxy group to the epoxy group in a range of 0.5 to 2.0, more preferably 0.7 to 1.5. Having an equivalent ratio in this range, the risk of lowering curability and mechanical properties can be prevented.

As the benzooxazine derivative, the ones shown by the following general formulae (3) and (4) can be preferably used, although it is not particularly limited.

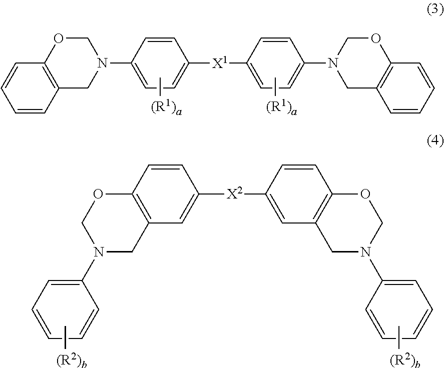

In the general formulae (3) and (4), X¹ and X² are each independently selected from the group consisting of an alkyl group having 1 to 10 carbon atoms, —O—, —NH—, —S—, —SO₂—, and a single bond; R¹ and R² each independently represent a hydrogen atom or a hydrocarbon group having 1 to 6 carbon atoms; and “a” and “b” are each independently an integer of 0 to 4.

In case of using both of the phenolic curing agent and the benzooxazine derivative, the preferable formulation ratio is (phenolic curing agent):(benzooxazine derivative)=99:1 to 1:99 in a mass ratio.

The use of acid anhydride as a curing agent allows the resin to have low dielectric properties.

### (E2) Silicone Resin

The silicone resin includes an addition curable silicone resin and a condensation curable silicone resin.

Illustrative examples of the addition curable silicone resin include the following ones shown by the average composition formula (5) and the average composition formula (6), for example.

An organopolysiloxane having at least two alkenyl group each bonded to a silicon atom in one molecule shown by the following average composition formula (5):

(Z¹₃SiO_{1/2})ₐ(Z¹₂SiO_{2/2})_{b}(Z¹SiO_{3/2})_{c}(SiOO_{4/2})_{d} (5)

wherein, each Z¹ independently represents a group selected from a hydroxy group, a linear, branched, or cyclic alkyl group having 1 to 10 carbon atoms, an aryl group having 6 to 10 carbon atoms, and an alkenyl group having 2 to 10 carbon atoms; and “a”, “b”, “c”, and “d” are numbers satisfying a≥0, b≥0, c≥0, d≥0, and a+b+c+d=1.

An organohydrogenpolysiloxane having at least 2 hydrogen atoms each bonded to a silicon atom in one molecule shown by the following average composition formula (6):

(Z²₃SiO_{1/2})ₑ(Z²₂SiO_{2/2})_{f}(Z²SiO_{3/2})_{g}(SiO_{4/2})ₕ (6)

wherein, each Z² represents a hydrogen atom or a group selected from a hydroxy group, a linear, branched, or cyclic alkyl group having 1 to 10 carbon atoms, and an aryl group having 6 to 10 carbon atoms; and “e”, “f”, “g, and “h” are numbers satisfying e≥0, f≥0, g≥0, h≥0, and e+f+g+h=1.

The silicone resin preferably contains an aryl group bonded to a silicon atom in an amount of 10 to 99 mol %, more preferably 15 to 80 mol %, particularly 17 to 75 mol % relative to the whole organic groups bonded to silicon atoms.

The condensation curable silicone resin includes the following.

An organohydrogenpolysiloxane having at least 2 hydrogen atoms each bonded to a silicon atom in one molecule shown by the following average composition formula (7):

(Z³₃SiO_{1/2})ᵢ(Z³₂SiO_{2/2})ⱼ(Z³SiO_{3/2})ₖ(SiO_{4/2})ₗ (7)

wherein, each Z³ represents a hydrogen atom or a group expect for an alkenyl group and selected from a hydroxy group, an alkoxy group, a linear, branched, or cyclic alkyl group having 1 to 10 carbon atoms, and an aryl group having 6 to 10 carbon atoms; and “i”, “j”, “k, and “l” are numbers satisfying i≥0, j≥0, k≥0, l≥0, and i+j+k+l=1.

The organohydrogenpolysiloxane shown by the average composition formula (7) condensates to cure by heating, and the curing is accelerated by (C) the curing accelerator.

### (E3) Curable Polyimide Resin

The curable polyimide resin is classified by the chemical properties of the reactive terminal group. The polyimide resin is preferably a one that is solid at room temperature, although it is not particularly limited.

### (E4) Cyanate Resin

The cyanate resin is not particularly limited if it has two or more cyanate groups in one molecule. This can be obtained by, for example, reaction of a halogenated cyan compound and phenolic compound or naphtholic compound, followed by heating in accordance with needs to form a prepolymer.

Illustrative examples of the cyanate resin include a novolak type cyanate resin, a bisphenol type cyanate resin, a naphtholaralkyl type cyanate resin, a dicyclopentadiene type cyanate resin, and a biphenylalkyl type cyanate resin. Among them, the one having a smaller cyanate group equivalent causes smaller cure shrinkage and affords a cured material with lower thermal expansion coefficient and higher glass transition temperature. They can be used alone or in combination of two or more kinds.

Additionally, a curing agent or a curing catalyst may be contained. The curing agent and the curing catalyst are not particularly limited and can be exemplified by the same kinds of curing materials and curing catalysts described above. For example, the curing agent includes a phenolic curing agent and a dihydroxynaphthalene compound; and the curing catalyst includes a primary amine and a metal complex.

### (E5) (Meth)Acrylic Resin

The (meth)acrylic resin includes polymers and copolymers of (meth)acrylic acid, (meth)acrylonitrile, (meth)acrylate, and (meth)acrylamide, and represents a resin that has a (meth)acrylic skeleton. It is not limited to a resin that is curable through the reactive group such as an acryloyl group or a methacryloyl group.

In order to adjust the curability, it is also possible to separately add a radical polymerization initiator such as peroxide, photo-polymerization initiator, and a curing accelerator to promote reaction of reactive group in the (meth)acrylic resin.

As these resins (E1) to (E5), the resin in each group may be used alone or in combination of two or more kinds. It is also possible to use two or more resins selected from various resin groups. In particular, the mixed composition of (B) the maleimide resin (compound) and (E4) the cyanate resin (compound) is known as a BT resin, and excels in processing properties, heat resistance, and electric properties.

### <Additive>

Additionally, the resin composition in the present invention may contain additives described below.

### (G) Flame Retardant

The resin composition in the present invention may contain a flame retardant to enhance the flame resistance. As the flame retardant, the type is not particularly limited, and any known flame retardant can be used. Illustrative examples of the flame retardant include a phosphazene compound, a silicone compound, zinc molybdate supported with talc, zinc molybdate supported with zinc oxide, aluminum hydroxide, magnesium hydroxide, molybdenum oxide, and antimony oxide. They may be used alone or in combination of two or more kinds. The amount of flame retardant is preferably 2 to 20 parts by mass, more preferably 3 to 10 parts by mass relative to 100 parts by mass of the total mass of the component (B) and the component (E).

### (H) Coupling Agent

The resin composition in the present invention can contain a coupling agent such as a silane coupling agent and a titanate coupling agent in order to increase bond strength of (D) the inorganic filler with the component (B) and the component (E) or to improve the adherence between the resin component and the metal foil.

Illustrative examples of the coupling agent include silane coupling agents including epoxy functional alkoxysilanes such as γ-glycidoxypropyltrimethoxysilane, γ-glycidoxypropylmethyldiethoxysilane, and β-(3,4-epoxycyclohexyl)ethyltrimethoxysilane; amino functional alkoxysilanes such as N-β-(aminoethyl)-γ-aminopropyltrimethoxysilane, γ-aminopropyltriethoxysilane, and N-phenyl-γ-aminopropyltrimethoxysilane; mercapto functional alkoxysilanes such as γ-mercaptopropyltrimethoxysilane; and titanate coupling agents such as isopropyltriisostearoyl titanate, tetraoctylbis(ditridecylphosphite) titanate, and bis(dioctylpyrophosphate)oxyacetate titanate.

The amount of coupling agent and the surface treatment method are not particularly limited and may be adopted ordinarily.

It is possible to treat (D) the inorganic filler with the coupling agent previously, and it is also possible to perform surface treatment by adding the coupling agent while mixing the inorganic filler and the resin component of the component (B) and the component (E) to prepare a composition.

The content of the component (H) is preferably 0.1 to 8.0 mass %, particularly 0.5 to 6.0 mass % relative to the total mass of the component (B) and the component (E). When the content is 0.1 mass % or more, the effect of adhesion to a substrate becomes sufficient. When the content is 8.0 mass % or less, extreme lowering of the viscosity is prevented to eliminate the risk of causing voids.

### (I) Thermoplastic Resin

In order to provide low dielectric properties for a high-frequency substrate, a thermoplastic resin, such as a fluorine-containing thermoplastic resin may be added. Preferable examples thereof include polytetrafluoroethylene (PTFE), polyethylene, polypropylene, polyvinyl chloride (PVC), polystyrene, polyvinyl alcohol (PVA), polyurethane, an acrylonitrile-butadiene-styrene resin (ABS), polymethyl methacrylate (PMMA), polyamide, polyacetal, polycarbonate, modified polyphenylene ether (PPE), polyethylene terephthalate (PET), cyclic polyolefin, polyphenylene sulfide, a liquid crystalline polymer, polyether ether ketone, thermoplastic polyimide, and polyamide imide. In view of low dielectric properties and heat resistance, PTFE, PPE, and so on are preferable. The surface of the thermoplastic resin may be subjected to surface treatment using inorganic material such as silica.

In order to improve the properties of the resin, other additives may be contained, including organopolysiloxane, silicone oil, thermoplastic elastomer, organic synthetic rubber, light stabilizer, pigment, and dye; and ion-trapping agent and so on may be added in order to improve the electric properties.

### [Quartz Glass Fiber-Containing Substrate]

The present invention also provides a quartz glass fiber-containing substrate composed of a cured material of one sheet of the quartz glass fiber-containing prepreg or a laminated cured material of two or more sheets of the quartz glass fiber-containing prepregs.

The inventive quartz glass fiber-containing prepreg (substrate) is a prepreg (substrate) having a relative dielectric constant of 3.0 or less, preferably 2.0 to 3.0, and a dielectric tangent of 0.0005 to 0.008, preferably 0.0005 to 0.006, in a range of 10 to 100 GHz, and is preferable because the loss of the electric signal to communicate substrate, which is referred to as transmission loss, is small even in a high frequency band. Incidentally, the dielectric constant and the dielectric tangent may be measured by appropriately selecting a method such as a cut-off cylindrical waveguide method.

Additionally, it is preferable that the dielectric tangent at 1 GHz and the dielectric tangent at 10 GHz differ by 0 to 0.01. In this range, the material is favorable to be applied to various electronic parts using the low dielectric properties.

The inventive quartz glass fiber-containing substrate can be produced by heat curing at least one sheet of the quartz glass fiber-containing prepreg, preferably a laminate of 1 to 20 sheets thereof. The conditions for heat curing may be previously known conditions, such as heating at 100 to 220° C. for 1 minute to 10 hours, optionally pressing at a pressure of 0.1 to 20 MPa simultaneously with heating in accordance with needs.

### EXAMPLES

Hereinafter, the present invention will be specifically described with reference to Examples and Comparative Examples, but the present invention is not limited thereto.

Each component used in Examples and Comparative Examples are shown below.

### <(A) Quartz Glass Fiber>

Glass cloths (A-1 to A-6) with a thickness of 0.1 mm were prepared using glasses shown in Table 1 below. Each quartz glass yarn was produced by setting 50 quartz glass rods to a jig, moving the vertical annular electric furnace with a maximum temperature of 2,000° C. downward, pulling the melted end portion continuously at high speed to give a synthetic quartz long staple with a fiber diameter of 5 μm, followed by throwing. The obtained quartz glass yarn was woven to produce quartz glass cloth, such as A-1 from natural quartz glass rod and A-2 from synthetic quartz glass rod. The contents of uranium and thorium (U, Th amounts) were measured by ICP-MS (Agilent 4500 manufactured by Agilent), and the total amount is described in Table 1. Incidentally, the average fiber diameter is a value measured by B method described in JIS R 3420:2013.

TABLE 1

| | A-1 | A-2 | A-3 | A-4 | A-5 | A-6 |
|---|---|---|---|---|---|---|
| Type of | Natural | Synthetic | E- | NE- | Natural | Natural |
| glass cloth | quartz | quartz | glass | glass | quartz | quartz |
| | glass | glass | | | glass | glass |
| U, Th amount | 0.011 | 0.005 | 15.1 | 1.65 | 0.011 | 0.011 |
| (ppm) | | | | | | |
| Average fiber | 3.0 | 3.0 | 3.5 | 3.5 | 2.0 | 10.0 |
| diameter (μm) | | | | | | |

### <(B) Maleimide Compound>

(B-1) Maleimide Compound-1 containing a linear alkyl group (BMI-2500, manufactures by Designer Molecules Inc.); U, Th amount: 0.0001 ppm
(B-2) Maleimide Compound-2 containing a linear alkyl group (BMI-5000, manufactures by Designer Molecules Inc.); U, Th amount: 0.0001 ppm

### <(C) Curing Accelerator>

(C-1) Peroxide (Percumyl D, manufactured by NOF CORPORATION); U, Th amount: 0.0001 ppm
(C-2) Imidazole-based catalyst (1B2PZ, manufactured by SHIKOKU CHEMICAL CORPORATION); U, Th amount: 0.0002 ppm

### <(D) Inorganic Filler>

(D) Spherical silica (SO-25H, manufactured by Admatechs Company Limited, average particle diameter: 0.5 μm); U, Th amount: 0.001 ppm

### <(E1) Epoxy Resin>

(E1-1) Multifunctional epoxy resin (EPPN-501H, manufactured by Nippon Kayaku Co., Ltd., epoxy equivalent: 165); U, Th amount: 0.001 ppm
(E1-1) Dicyclopentadiene type epoxy resin (HP-7200, manufactured by DIC Corporation, epoxy equivalent: 259); U, Th amount: 0.001 ppm

### <(E2) Silicone Resin>

(E2-1) Organosiloxane-1, having 73.5 mol % of (PhSiO_{3/2}) unit, 1.0 mol % of (MeViSiO_{2/2}) unit, and 25.5 mol % of (Me₂ViSiO_{1/2}) unit, U and Th could not be detected
(E2-2) Organosiloxane-2, having 4.7 mol % of (PhSiO_{3/2}) unit, 88.4 mol % of (PhMeSiO_{2/2}) unit, 2.2 mol % of (Me₂ViSiO_{1/2}) unit, and 4.7 mol % of (MePh₂SiO_{1/2}) unit, U and Th could not be detected
(E2-3) Organohydrogensiloxane-1, having 33.3 mol % of (Ph₂SiO_{2/2}) unit and 66.7 mol % of (Me₂HSiO_{1/2}) unit, U and Th could not be detected

### <(F) Curing Agent>

### Phenolic Curing Agent

Phenol novolak type phenolic curing agent (TD-2131, manufactured by DIC Corporation, phenolic hydroxy group equivalent: 104); U, Th amount: 0.001 ppm

### Acid Anhydride Type Curing Agent

RIKACID MH700 (manufactured by New Japan Chemical Co., Ltd., acid anhydride equivalent: 163); U, Th amount: 0.001 ppm

### (H) Thermoplastic Resin

Thermoplastic resin of PTFE with the surface being modified with silica (average particle diameter: 0.5 μm, manufactured by Admatechs Company Limited); U, Th amount: 0.001 ppm

Solvent for dilution:toluene, in an amount to make the volatile content be 50%

### Examples 1 to 18, Comparative Examples 1 to 5

In accordance with formulations (parts by mass) shown in Tables 2 to 4, each components other than the component (A) were melted and mixed to prepare each resin composition. Each glass cloth shown in Table 1 was impregnated with the prepared resin composition, and this was dried at 100° C. for 3 minutes to produce a prepreg. In all of the prepregs, the amount of attached resin composition was 60 mass %. This was further subjected to main curing at 180° C. for 4 hours to produce a cured material. The following properties were measured. The results are shown in Tables 2 to 4.

### <Peel Strength>

A general copper foil 1 (CF-T9LK-UN18, thickness: 18 μm, manufactured by FUKUDA METAL FOIL & POWDER CO., LTD.) or a high-frequency compatible copper foil (CF-V9S-SV18, thickness: 18 am, manufactured by FUKUDA METAL FOIL & POWDER CO., LTD.) and 5 sheets of prepreg produced in each Examples and Comparative Examples were laminated and cured at 180° C. for 4 hours. The peel strength (N/25 mm) between the prepreg and the copper foil was measured in accordance with JIS C 6481:1996. The peel strength (N/25 mm) was also measured for a sample after a heat resistance test in an oven at 200° C. for 1,000 hours.

### <Dielectric Properties>

A molded piece with a thickness of 0.5 mm in a scrap of 3 cm×15.5 cm was prepared for 1 GHz. A molded piece with a thickness of 0.15 mm in a scrap of 3 cm×4 cm was prepared for 10 GHz. A molded piece with a thickness of 0.2 mm in a scrap of 1 cm×1 cm was prepared for 77 GHz. The dielectric constant and the dielectric tangent of the film were measured at the frequency of 1 GHz and 10 GHz after connecting a network analyzer (E5063-2D5, manufactured by Keysight Technologies) and strip lines (manufactured by KEYCOM Corp.). The moduli of the dielectric tangent at 1 GHz and the dielectric tangent at 10 GHz were measured as tan δ1 and tan δ2 respectively. The dielectric constant and the dielectric tangent at 77 GHz were measured by a cut-off cylindrical waveguide method using a network analyzer (N5227A, manufactured by Keysight Technologies).

### <Drilling Workability>

Two sheets of general copper foil (CF-T9LK-UN18, thickness: 18 μm, manufactured by FUKUDA METAL FOIL & POWDER CO., LTD.) and two sheets of each prepreg of Examples and Comparative Examples were cured under the conditions of 4 MPa at 180° C. for 4 hours to produce a laminated substrate. This was subjected to 100 drilling works with a drill having a diameter of 200 μm, followed by electroless copper plating, and the face subjected to the drilling works and the plated portion were evaluated as “bad” when many failures were observed, “fair” when failures were scarcely observed, or “fine” when no failure was observed.

### <Malfunction Test>

With two sheets of copper foil having a thickness of 18 μm, two sheets of the prepregs were sandwiched at the both surfaces, and this was cured at 180° C. for 4 hours. This was made into a substrate having a 10 μm of Line & Space (L/S) pattern, and 20 DRAMs were mounted thereon and driven at a temperature of 150° C. and a frequency of 10 GHz for 1,000 hours. The substrate was evaluated as “bad” when even one DRAM caused malfunction, or “fine” when no malfunction was caused.

TABLE 2

| Formulation table of composition | | | Examples | | | | | | | | |
|---|---|---|---|---|---|---|---|---|---|---|---|
| (parts by mass except for A) | | | 1 | 2 | 3 | 4 | 5 | 6 | 7 | 8 | 9 |
| (A) | Natural quartz glass | A-1 | 100% | | 100% | | 100% | | 100% | | 100% |
| | cloth | | | | | | | | | | |
| | Synthetic quartz glass | A-2 | | 100% | | 100% | | 100% | | 100% | |
| | cloth | | | | | | | | | | |
| | E-glass | A-3 | | | | | | | | | |
| | NE-glass | A-4 | | | | | | | | | |
| | Natural quartz glass | A-5 | | | | | | | | | |
| | cloth¹⁾ | | | | | | | | | | |
| | Natural quartz glass | A-6 | | | | | | | | | |
| | cloth²⁾ | | | | | | | | | | |

| (B) | Maleimide | BMI-2500 | B-1 | 100.0 | | 100.0 | | 50.0 | | 50.0 | | 20.0 |
|---|---|---|---|---|---|---|---|---|---|---|---|---|
| | compound | BMI-5000 | B-2 | | 100.0 | | 100.0 | | 50.0 | | 50.0 | |
| (C) | Curing | Percumyl D | C-1 | 2.0 | 2.0 | 2.0 | 2.0 | 1.0 | 1.0 | 1.0 | 1.0 | 0.4 |
| | accelerator | 1B2PZ | C-2 | | | | | 0.3 | 0.3 | | | 0.4 |
| (D) | Filler | SO-25H | D-1 | 400.0 | 400.0 | 350.0 | 350.0 | 300.0 | 300.0 | 300.0 | 300.0 | 350.0 |
| (E1) | Epoxy | EPPN-501H | E1-1 | | | | | 28.2 | | 28.2 | | 49.1 |
| | resin | HP-7200 | E1-2 | | | | | | 33.5 | | 33.5 | |
| (E2) | Silicone | Organo- | E2-1 | | | | | | | | | |
| | resin | siloxane-1 | | | | | | | | | | |
| | | Organo- | E2-2 | | | | | | | | | |
| | | siloxane-2 | | | | | | | | | | |
| | | Organo- | E2-3 | | | | | | | | | |
| | | hydrogen- | | | | | | | | | | |
| | | siloxane-1 | | | | | | | | | | |
| (F) | Curing | TD-2131 | F-1 | | | | | 17.8 | 13.5 | | | 30.9 |
| | agent | MH700 | F-2 | | | | | | | 21.0 | 13.4 | |
| | Curing | U-CAT 5003 | | | | | | | | 0.1 | 0.1 | |
| | catalyst | 2% Pt | | | | | | | | | | |
| | | solution³⁾ | | | | | | | | | | |
| (G) | Coupling agent: | | | 2.0 | 2.0 | 2.0 | 2.0 | 2.0 | 2.0 | 2.0 | 2.0 | |
| | KBM-403 | | | | | | | | | | | |
| (H) | Thermoplastic resin: | | H-1 | | | 50.0 | 50.0 | 100.0 | 100.0 | 100.0 | 100.0 | 50.0 |
| | PTFE/SiO₂ | | | | | | | | | | | |
| Eval. | U, Th amount | | ppm | 0.013 | 0.007 | 0.013 | 0.007 | 0.015 | 0.007 | 0.015 | 0.007 | 0.016 |
| Re- | Peel | Conv./initial | N/ | 15.0 | 14.0 | 14.5 | 13.8 | 16.0 | 15.2 | 16.0 | 15.2 | 12.3 |
| sult | strength⁴⁾ | Low rough/ | 25 mm | 12.0 | 11.0 | 11.2 | 11.0 | 13.0 | 12.3 | 13.0 | 12.3 | 10.5 |
| | | initial | | | | | | | | | | |
| | | Conv./ | | 14.0 | 13.5 | 13.1 | 13.5 | 15.0 | 12.6 | 15.0 | 12.6 | 11.0 |
| | | 200° C. | | | | | | | | | | |
| | | Low rough/ | | 11.5 | 11.0 | 10.8 | 10.5 | 12.4 | 10.3 | 12.4 | 10.3 | 9.6 |
| | | 200° C. | | | | | | | | | | |
| | Dielectric | Dielectric | 1 GHz | 2.6 | 2.5 | 2.5 | 2.4 | 2.9 | 2.9 | 2.8 | 2.8 | 3.0 |
| | properties | constant | 10 GHz | 2.5 | 2.4 | 2.4 | 2.3 | 2.8 | 2.8 | 2.7 | 2.7 | 2.9 |
| | | | 77 GHz | 2.4 | 2.3 | 2.3 | 2.2 | 2.7 | 2.7 | 2.6 | 2.6 | 2.9 |
| | | Dielectric | 1 GHz | 0.0020 | 0.0010 | 0.0010 | 0.0008 | 0.0031 | 0.0038 | 0.0028 | 0.0030 | 0.0046 |
| | | tangent | 10 GHz | 0.0030 | 0.0020 | 0.0018 | 0.0013 | 0.0048 | 0.0055 | 0.0041 | 0.0046 | 0.0075 |
| | | | 77 GHz | 0.0050 | 0.0040 | 0.0045 | 0.0032 | 0.0065 | 0.0071 | 0.0057 | 0.0059 | 0.0110 |

| | | | | | | | | | |
|---|---|---|---|---|---|---|---|---|---|
| \|tan δ1 − tan δ2\| | 0.0010 | 0.0010 | 0.0008 | 0.0005 | 0.0017 | 0.0017 | 0.0013 | 0.0016 | 0.0029 |

| | | | | | | | | | |
|---|---|---|---|---|---|---|---|---|---|
| Drilling workability | fine | fine | fine | fine | fine | fine | fine | fine | fine |
| Malfunction test | fine | fine | fine | fine | fine | fine | fine | fine | fine |

¹⁾strand diameter: 2.0 μm
²⁾strand diameter: 10.0 μm
³⁾octanol solution
⁴⁾conv.: conventional copper foil, Low rough: low roughness (high-frequency compatible) copper foil, 200° C.: after heat resistance test at 200° C.

TABLE 3

| Formulation table of composition | | | | Examples | | | | | | | | |
|---|---|---|---|---|---|---|---|---|---|---|---|---|
| (parts by mass except for A) | | | | 10 | 11 | 12 | 13 | 14 | 15 | 16 | 17 | 18 |
| (A) | Natural quartz glass | | A-1 | | 100% | | 100% | | 100% | | | |
| | cloth | | | | | | | | | | | |
| | Synthetic quartz glass | | A-2 | 100% | | 100% | | 100% | | 100% | | |
| | cloth | | | | | | | | | | | |
| | E-glass | | A-3 | | | | | | | | | |
| | NE-glass | | A-4 | | | | | | | | | |
| | Natural quartz glass | | A-5 | | | | | | | | 100% | |
| | cloth¹⁾ | | | | | | | | | | | |
| | Natural quartz glass | | A-6 | | | | | | | | | 100% |
| | cloth²⁾ | | | | | | | | | | | |
| (B) | Maleimide | BMI-2500 | B-1 | | 20.0 | | 50.0 | | 20.0 | | 100.0 | |
| | compound | BMI-5000 | B-2 | 20.0 | | 20.0 | | 50.0 | | 20.0 | | 100.0 |
| (C) | Curing | Percumyl D | C-1 | 0.4 | 0.4 | 0.4 | 1.0 | 1.0 | 1.0 | 1.0 | 2.0 | 2.0 |
| | accelerator | 1B2PZ | C-2 | 0.4 | 0.4 | 0.4 | | | | | | |
| (D) | Filler | SO-25H | D-1 | 350.0 | 350.0 | 350.0 | 400.0 | 400.0 | 200.0 | 200.0 | 400.0 | 400.0 |
| (E1) | Epoxy | EPPN-501H | E1-1 | | 40.2 | | | | | | | |
| | resin | HP-7200 | E1-2 | 57.1 | | 49.1 | | | | | | |
| (E2) | Silicone | Organo- | E2-1 | | | | 28.6 | 28.6 | 45.8 | 45.8 | | |
| | resin | siloxane-1 | | | | | | | | | | |
| | | Organo- | E2-2 | | | | 11.5 | 11.5 | 18.3 | 18.3 | | |
| | | siloxane-2 | | | | | | | | | | |
| | | Organo- | E2-3 | | | | 9.9 | 9.9 | 15.9 | 15.9 | | |
| | | hydrogen- | | | | | | | | | | |
| | | siloxane-1 | | | | | | | | | | |
| (F) | Curing | TD-2131 | F-1 | 22.9 | | | | | | | | |
| | agent | MH700 | F-2 | | 39.8 | 30.9 | | | | | | |
| | Curing | U-CAT 5003 | | | | | | | | | | |
| | catalyst | 2% Pt | | | | | 0.002 | 0.002 | 0.003 | 0.003 | | |
| | | solution³⁾ | | | | | | | | | | |
| (G) | Coupling agent: | | | 2.0 | 2.0 | 2.0 | 2.0 | 2.0 | 2.0 | 2.0 | 2.0 | 2.0 |
| | KBM-403 | | | | | | | | | | | |
| (H) | Thermoplastic resin: | | H-1 | 50.0 | 50.0 | 50.0 | | | 50.0 | 50.0 | | |
| | PTFE/SiO₂ | | | | | | | | | | | |
| Eval. | U, Th amount | | ppm | 0.008 | 0.016 | 0.008 | 0.012 | 0.006 | 0.012 | 0.006 | 0.012 | 0.006 |
| Re- | Peel | Conv./initial | N/ | 13.8 | 11.5 | 11.6 | 8.5 | 7.8 | 7.5 | 6.8 | 15.0 | 14.0 |
| sult | strength⁴⁾ | Low rough/ | 25 mm | 11.0 | 10.4 | 10.8 | 5.6 | 4.5 | 4.8 | 4.3 | 12.0 | 11.0 |
| | | initial | | | | | | | | | | |
| | | Conv./ | | 13.5 | 11.4 | 11.4 | 8.2 | 7.7 | 7.2 | 6.8 | 14.0 | 13.5 |
| | | 200° C. | | | | | | | | | | |
| | | Low rough/ | | 10.5 | 10.3 | 10.6 | 5.0 | 4.4 | 4.7 | 4.3 | 11.5 | 11.0 |
| | | 200° C. | | | | | | | | | | |
| | Dielectric | Dielectric | 1 GHz | 3.0 | 2.9 | 2.9 | 2.6 | 2.5 | 2.5 | 2.4 | 2.6 | 2.5 |
| | properties | constant | 10 GHz | 2.9 | 2.8 | 2.8 | 2.5 | 2.4 | 2.4 | 2.3 | 2.5 | 2.4 |
| | | | 77 GHz | 2.9 | 2.7 | 2.7 | 2.4 | 2.3 | 2.3 | 2.2 | 2.4 | 2.3 |
| | | Dielectric | 1 GHz | 0.0051 | 0.0038 | 0.0044 | 0.0020 | 0.0010 | 0.0031 | 0.0028 | 0.0020 | 0.0010 |
| | | tangent | 10 GHz | 0.0082 | 0.0051 | 0.0061 | 0.0030 | 0.0020 | 0.0042 | 0.0041 | 0.0030 | 0.0020 |
| | | | 77 GHz | 0.0109 | 0.0093 | 0.0088 | 0.0050 | 0.0040 | 0.0061 | 0.0066 | 0.0050 | 0.0040 |

| | | | | | | | | | |
|---|---|---|---|---|---|---|---|---|---|
| \|tan δ1 − tan δ2\| | 0.0031 | 0.0013 | 0.0017 | 0.0010 | 0.0010 | 0.0011 | 0.0013 | 0.0010 | 0.0010 |

| | | | | | | | | | |
|---|---|---|---|---|---|---|---|---|---|
| Drilling workability | fine | fine | fine | fine | fine | fine | fine | fair | fair |
| Malfunction test | fine | fine | fine | fine | fine | fine | fine | fine | fine |

¹⁾strand diameter: 2.0 μm
²⁾strand diameter: 10.0 μm
³⁾octanol solution
⁴⁾conv.: conventional copper foil, Low rough: low roughness (high-frequency compatible) copper foil, 200° C.: after heat resistance test at 200° C.

TABLE 4

| Formulation table of composition | | | | Comparative Examples | | | | |
|---|---|---|---|---|---|---|---|---|
| (parts by mass except for A) | | | | 1 | 2 | 3 | 4 | 5 |
| (A) | Natural quartz glass cloth | | A-1 | | | | | 85% |
| | Synthetic quartz glass cloth | | A-2 | | | | | |
| | E-glass | | A-3 | 100% | | 100% | | |
| | NE-glass | | A-4 | | 100% | | 100% | 15% |
| | Natural quartz glass cloth¹⁾ | | A-5 | | | | | |
| | Natural quartz glass cloth²⁾ | | A-6 | | | | | |
| (B) | Maleimide | BMI-2500 | B-1 | | | 100.0 | | 100.0 |
| | compound | BMI-5000 | B-2 | | | | 100.0 | |
| (C) | Curing | Percumyl D | C-1 | | | 2.0 | 2.0 | 2.0 |
| | accelerator | 1B2PZ | C-2 | 0.6 | 0.6 | | | |
| (D) | Filler | SO-25H | D-1 | | | 400.0 | 400.0 | 400.0 |
| (E1) | Epoxy | EPPN-501H | E1-1 | 61.3 | | | | |
| | resin | HP-7200 | E1-2 | | 71.3 | | | |
| (E2) | Silicone | Organosiloxane-1 | E2-1 | | | | | |
| | resin | Organosiloxane-2 | E2-2 | | | | | |
| | | Organohydrogen- | E2-3 | | | | | |
| | | siloxane-1 | | | | | | |
| (F) | Curing | TD-2131 | F-1 | 38.7 | 28.7 | | | |
| | agent | MH700 | F-2 | | | | | |
| | Curing | U-CAT 5003 | | | | | | |
| | catalyst | 2% Pt solution³⁾ | | | | | | |
| (G) | Coupling agent: KBM-403 | | | 2.0 | 2.0 | 2.0 | 2.0 | 2.0 |
| (H) | Thermoplastic resin: PTFE/SiO₂ | | H-1 | 1.5 | 1.5 | | | |
| Eval. | U, Th amount | | ppm | 15.10 | 1.65 | 15.10 | 1.65 | 0.20 |
| Result | Peel | Conv./initial | N/ | 16.0 | 15.2 | 14.5 | 13.8 | 13 |
| | strength⁴⁾ | Low rough/initial | 25 mm | 13.0 | 12.3 | 11.2 | 11.0 | 10.5 |
| | | Conv./200° C. | | 15.0 | 12.6 | 13.1 | 13.5 | 10.3 |
| | | Low rough/200° C. | | 12.4 | 10.3 | 10.8 | 10.5 | 8.2 |
| | Dielectric | Dielectric | 1 GHz | 3.8 | 3.9 | 3.5 | 3.3 | 2.9 |
| | properties | constant | 10 GHz | 3.7 | 3.8 | 3.4 | 3.2 | 2.8 |
| | | | 77 GHz | 3.6 | 3.7 | 3.3 | 3.1 | 2.7 |
| | | Dielectric | 1 GHz | 0.0182 | 0.0222 | 0.0205 | 0.0138 | 0.0049 |
| | | tangent | 10 GHz | 0.0365 | 0.0456 | 0.0455 | 0.0399 | 0.0125 |
| | | | 77 GHz | 0.0877 | 0.0971 | 0.0588 | 0.0515 | 0.0258 |

| | | | | | |
|---|---|---|---|---|---|
| \|tan δ1 − tan δ2\| | 0.0183 | 0.0234 | 0.0450 | 0.0261 | 0.0076 |

| | | | | | |
|---|---|---|---|---|---|
| Drilling workability | fine | fine | fine | fine | fine |
| Malfunction test | bad | bad | bad | bad | bad |

¹⁾strand diameter: 2.0 μm
²⁾strand diameter: 10.0 μm
³⁾octanol solution
⁴⁾conv.: conventional copper foil, Low rough: low roughness (high-frequency compatible) copper foil, 200° C.: after heat resistance test at 200° C.

As shown in Tables 2 to 4, it was found that the quartz glass fiber-containing prepreg and the quartz glass fiber-containing substrate of the present invention have lower dielectric constants, and the substrate allows a semiconductor device to be prevented from malfunctioning, thereby being useful for onboard use and a high-frequency compatible substrate.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

1. A quartz glass fiber-containing prepreg, comprising:
(A) at least one quartz glass fiber selected from the group consisting of a quartz cloth, a quartz chopped strand, a quartz nonwoven fabric, and a quartz wool; and
a resin composition comprising:
(B) a maleimide compound that is a solid at 25° C., containing at least one dimer acid skeleton, at least one linear alkylene group having 6 or more carbon atoms, and at least two maleimide groups in the molecule; and
(C) a curing accelerator,
wherein the prepreg has a total content of uranium and thorium of 0 to 0.1 ppm.

2. The quartz glass fiber-containing prepreg according to claim 1, further comprising (D) inorganic filler.

3. The quartz glass fiber-containing prepreg according to claim 1, wherein (A) the quartz glass fiber has a fiber diameter of 3 to 9 μm and a fictive temperature of 1,200 to 1,600° C.

4. The quartz glass fiber-containing prepreg according to claim 2, wherein (A) the quartz glass fiber has a fiber diameter of 3 to 9 μm and a fictive temperature of 1,200 to 1,600° C.

5. The quartz glass fiber-containing prepreg according to claim 1, wherein the resin composition further contains (E) at least one curable resin selected from the group consisting of a silicone resin, a curable polyimide resin, an epoxy resin, a cyanate resin, and a (meth)acrylic resin.

6. The quartz glass fiber-containing prepreg according to claim 2, wherein the resin composition further contains (E) at least one curable resin selected from the group consisting of a silicone resin, a curable polyimide resin, an epoxy resin, a cyanate resin, and a (meth)acrylic resin.

7. The quartz glass fiber-containing prepreg according to claim 3, wherein the resin composition further contains (E) at least one curable resin selected from the group consisting of a silicone resin, a curable polyimide resin, an epoxy resin, a cyanate resin, and a (meth)acrylic resin.

8. The quartz glass fiber-containing prepreg according to claim 4, wherein the resin composition further contains (E) at least one curable resin selected from the group consisting of a silicone resin, a curable polyimide resin, an epoxy resin, a cyanate resin, and a (meth)acrylic resin.

9. The quartz glass fiber-containing prepreg according to claim 1, wherein (B) the maleimide compound is shown by at least one of the following general formulae (1) and (2): 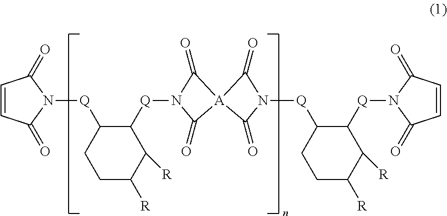
wherein “A” represents a quadrivalent organic group containing an aromatic ring or an aliphatic ring, Q represents a linear alkylene group having 6 or more carbon atoms, each R independently represents a linear or branched alkyl group having 6 or more carbon atoms, and “n” is an integer of 1 to 10, 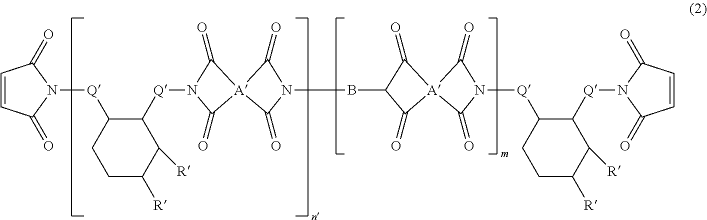
wherein “A′” represents a quadrivalent organic group containing an aromatic ring or an aliphatic ring, B represents an alkylene chain having 6 to 18 carbon atoms and an aliphatic ring optionally containing at least one divalent hetero atom, Q′ represents a linear alkylene group having 6 or more carbon atoms, each R′ independently represents a linear or branched alkyl group having 6 or more carbon atoms, “n′” is an integer of 1 to 10, and “m” is an integer of 1 to 10.

10. The quartz glass fiber-containing prepreg according to claim 9, wherein the general formula (1) and the general formula (2) have any of the following structures as “A” and “A′” 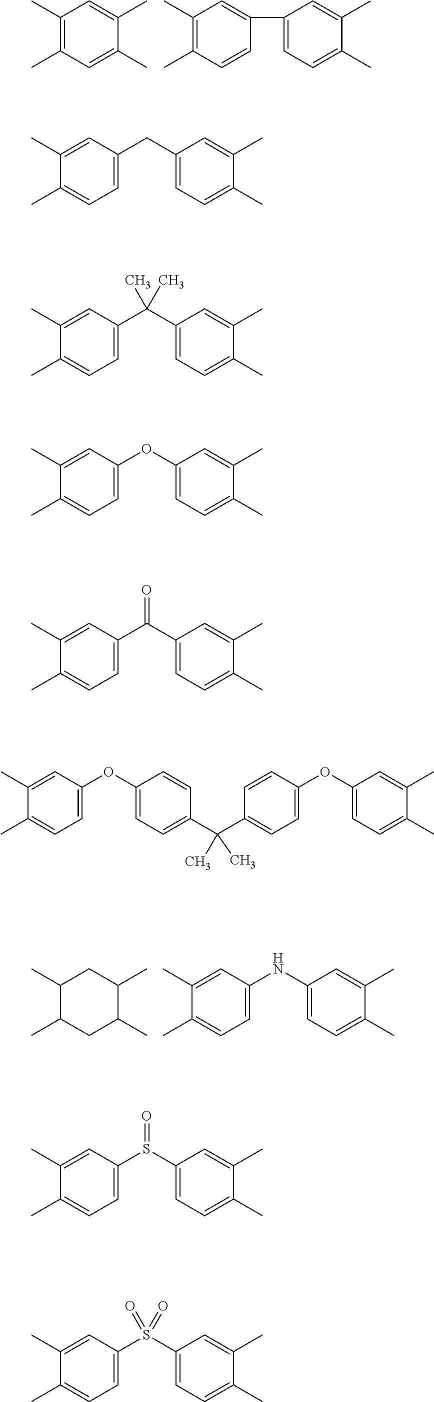
wherein each bond without having a substituent in the structural formulae is bonded to a carbonyl carbon atom forming a cyclic imide structure in the general formula (1) or the general formula (2).

11. A quartz glass fiber-containing substrate, comprising a cured material of a sheet composed of the quartz glass fiber-containing prepreg according to claim 1 or a laminated cured material of the sheets, the substrate having a relative dielectric constant of 3.0 or less and a dielectric tangent of 0.0005 to 0.008 in a range of 10 to 100 GHz.

12. The quartz glass fiber-containing substrate according to claim 11, wherein the dielectric tangent at 1 GHz and the dielectric tangent at 10 GHz differ by 0 to 0.01.
